(19) United States
(12) Patent Application Publication
(10) Pub. No.: US 2011/0242796 A1
(43) Pub. Date: Oct. 6, 2011

(54) BACKLIGHT UNIT

(76) Inventors: Se Woo YANG, Daejeon (KR); Woo Ha Kim, Daejeon (KR); Suk Ky Chang, Daejeon (KR); Seung Choon Bae, Suwon-si (KR); Soonhyung Kwon, Seoul (KR); Sungwoo Kim, Seoul (KR); Sang-Tae Park, Yongin-si (KR); Bup Sung Jung, Seoul (KR)

(21) Appl. No.: 13/162,403

(22) Filed: Jun. 16, 2011

Related U.S. Application Data
(63) Continuation of application No. PCT/KR2010/007819, filed on Nov. 5, 2010.

(30) Foreign Application Priority Data
Nov. 5, 2009 (KR) 10-2009-0106683
Nov. 5, 2009 (KR) 10-2009-0106684
Nov. 5, 2010 (KR) 10-2010-0109521
Nov. 5, 2010 (KR) 10-2010-0109523

(51) Int. Cl. G02F 1/13357; B32B 37/12; B05D 5/10

(52) U.S. Cl. 362/97.1; 156/60; 427/208.4

(57) ABSTRACT

The present invention relates to a backlight unit. In the present invention, the backlight unit is constituted by attaching the pressure sensitive adhesive formulated with light scattering particles to a substrate that light emitting bodies are present. Said pressure sensitive adhesive does not cause looseness, peel-off and curl even in a severe condition such as high temperature or high temperature and high humidity as well as a phenomenon such as yellowing or whitening. Therefore, the present invention may provide a unit having high brightness and excellent luminance uniformity, overcoming step height due to the light emitting body and having thin thickness, and is also advantageous to be applied to a flexible device.

### TECHNICAL FIELD

The present invention relates to a backlight unit.

### BACKGROUND ART

A backlight unit (BLU) is a light source device included in a display device. For example, liquid crystals themselves do not emit light, so that a liquid crystal screen in a liquid crystal display (LCD) is represented by reflecting the front incident light in the rear mirror of the liquid crystal to emit it, or generating light at a rear backlight unit.

The backlight unit is directly related to brightness, consumed power, and the like, of the display device. Design of a light guide plate, a diffuser sheet or a diffuser plate, and the like, to be capable of improving performance of the unit, design of shape or disposition in light emitting bodies such as cold-cathode tubes or light emitting diodes (LEDs), or research for emitting light by low power, and the like, is proceeding. In addition, an attempt for brightness to be improved by positioning an optical device such as a diffuser plate or a retroreflective plate on the upper part of a light source or a light guide plate has also been made.

### DISCLOSURE

### Technical Problem

An object of the present invention is provide a backlight unit.

### Technical Solution

The present invention relates to a backlight unit that comprises a substrate, on which a light emitting body is present; and a pressure sensitive adhesive pad that is attached on said substrate. The pressure sensitive adhesive pad comprises a pressure sensitive adhesive layer which is a cured product of a pressure sensitive adhesive composition that comprises a monomeric or a polymeric component and a light scattering particle.

The backlight unit is explained in detail below.

A backlight unit is a light source that can be used in a display device such as a liquid crystal display. In one embodiment, the backlight unit may be a direct type backlight unit.

FIG. 1 shows a cross-section view of schematically representing one embodiment of the backlight unit (1). The backlight unit (1) may comprise a substrate (10) and light emitting bodies (20) disposed on said substrate (10) as in FIG. 1.

A kinds of the substrate and the light emitting bodies present on the upper part of the substrate, which are included in the unit, are not particularly limited. In one embodiment, said substrate may be a printed circuit board (PCB), and the light emitting body may be a light emitting diode (LED). The LEDs as above may be arranged in a predetermined pattern on the PCB. A kind of the substrate and the light emitting body, and designing method thereof are not particularly limited. Various structures, raw materials and designing method of the substrate and the light emitting body to be capable of being used in the backlight unit are known in the field, and all these contexts may be applied to said backlight unit.

Said unit comprises a pressures sensitive adhesive pad comprising a pressure sensitive adhesive layer attached to the upper part of said substrate. Here, said pressure sensitive adhesive pad may be composed of a monolayer of said pressure sensitive adhesive layer, and if appropriate, comprise other optical films or release films formed on one or both sides of said pressure sensitive adhesive layer. Preferably, said pressure sensitive adhesive layer herein is “surface-attached” to the upper part of the substrate. Here, the term “a pressure sensitive adhesive layer surface-attached to the upper part of the substrate” means that in the substrate, on the upper part of which at least one light emitting body is present, the pressures sensitive adhesive layer is attached on the whole surface of the upper part of the substrate and the light emitting body, and therefore air gap is substantially not present between the pressures sensitive adhesive layer and the surface of said substrate and light emitting bodies. FIG. 1 represents one embodiment of a structure in which a pressure sensitive adhesive pad (30) having a pressure sensitive adhesive layer (31) comprising light scattering particles (32) therein is surface-attached to a substrate (10), on the upper part of which light emitting bodies (20) are present.

Here, the pressure sensitive adhesive layer attached to the upper part of the substrate comprises light scattering particles. The light scattering particles herein mean particles that they have a refractive index different from a pressure sensitive adhesive, so that they may serve to scatter incident light emitted from light emitting bodies. In addition, the pressure sensitive adhesive is a kind of adhesive materials and represents a viscoelastic characteristic with maintaining a semi-solid state, while an adhesive is generally changed from a liquid phase to a solid phase after attachment. By said characteristic of the pressure sensitive adhesive, the pressure sensitive adhesive pad may be effectively attached to a substrate, with effectively overcoming step height due to the light emitting bodies. Also, said pressure sensitive adhesive pad does not cause curl, looseness and peel-off, and the like, even in a severe condition such as high temperature or high temperature and high humidity. Introduction of the pressure sensitive adhesive is also effective for constituting a flexible device. In addition, said light scattering particles let the pad scatter light from the light emitting bodies, so that a uniform and thin surface light source may be embodied. Furthermore, said pressure sensitive adhesive pad can reduce bright points of the light emitting bodies and inhibit light loss via an air gap which has been a conventional problem.

Said pressure sensitive adhesive layer in the pressure sensitive adhesive pad may be formed by curing a pressures sensitive adhesive composition comprising a monomeric or polymeric component; and a light scattering particle. Here, curing of the pressure sensitive adhesive composition means a procedure of converting said pressures sensitive adhesive composition into a pressure sensitive adhesive through a procedure such as crosslinkage and/or polymerization by a drying, a heating, an aging and/or a light irradiating, and the like. Also, the monomeric or polymeric component is a component to form a base in the pressures sensitive adhesive via the curing procedure as above. In addition, the term “polymeric component” is the general term referring to compounds formed by polymerizing two or more monomers, and, for example, the “polymeric component” may include a component which is conventionally called as an oligomer in the field. In the field of preparing pressure sensitive adhesives, various monomeric or polymeric components for preparing the pressure sensitive adhesive compositions are known, and theses components can be used herein without any limitation.

When a pressure sensitive adhesive composition is, for example, a thermocurable composition, said monomeric or polymeric component may include an acrylic polymer having a crosslinkable functional group. Here, the specific kind of usable polymers is not particularly limited, and a polymer to be usually used as a pressure sensitive adhesive resin, such as an acrylic polymer comprising, in a polymerized form, (meth)acrylic acid alkyl ester and a copolymerizable monomer which is capable of providing a side chain or a terminal of the polymer with a crosslinkable functional group may be used. The specific example of (meth)acrylic acid alkyl ester may include alkyl (meth)acrylate having an alkyl group with 1 to 14 carbon atoms such as methyl (meth)acrylate, ethyl (meth)acrylate, butyl (meth)acrylate or ethylhexyl (meth)acrylate. In addition, a monomer having, in its molecule, a copolymerizable functional group such as an ethylenic double bond and a crosslinkable functional group such as a hydroxy group, a carboxyl group, an epoxy group, an isocyante group or an amide group together may be used as said copolymerizable monomer, wherein these monomers are widely known in this field.

A ratio by weight of each monomer included in the acrylic polymer having the above crosslinkable functional group is not particularly limited, and may be controlled considering initial adhesion strength, bond strength and cohesiveness of the desired pressure sensitive adhesive. In addition, said acrylic polymer may optionally comprise various copolymerizable monomers in a polymerized form, in addition to those mentioned above. Said polymer may be prepared by a conventional polymerization method in this field, such as a solution polymerization, a photo polymerization, a bulk polymerization, a suspension polymerization or an emulsion polymerization.

The thermocurable pressure sensitive adhesive composition may further comprise, together with the aforementioned acrylic polymer, a multifunctional crosslinking agent being capable of crosslinking said polymer. Here, the usable specific crosslinking agent is not particularly limited to any kind, and for example, a known crosslinking agent such as an isocyanate crosslinking agent, an epoxy crosslinking agent, an aziridine crosslinking agent and a metal chelate crosslinking agent may be used. In addition, a ratio of said crosslinking agent in the composition is not particularly limited, and may be suitably controlled considering the desired cohesiveness, and the like.

Said pressures sensitive adhesive composition may be also formulated in a photocurable pressure sensitive adhesive composition. Here, the term “a photocurable pressure sensitive adhesive composition” means a composition which is converted into a pressure sensitive adhesive through any curing procedure derived by light irradiation, that is, electromagnetic wave irradiation. Said electromagnetic wave is used as the general term including microwaves, IRs, UVs, X-rays, γ-rays or particle beams such as α-particle beams, proton beams, neutron beams and electron beams.

When the pressure sensitive adhesive composition is formulated to be photocurable, said monomeric or polymeric component may comprise a photocurable oligomer and a reactive diluent monomer. An example of the above photocurable oligomer may include all the oligomer components to be used in preparing a photocurable pressures sensitive adhesive composition such as a UV curable composition in this field. For example, said oligomer may include urethane acrylates obtained by reacting polyisocyanate having at least two isocyanate groups in its molecule and hydroxyalkyl (meth)acrylate; ester acrylates obtained by dehydration and condensation reaction of polyester polyol and (meth)acrylic acid; ester urethane acrylates obtained by reacting an ester urethane resin, which is obtained from reaction of polyester polyol and polyisocyanate, with hydroxyalkyl acrylate; ether acrylates such as polyalkyleneglycol di(meth)acrylate; ether urethane acrylate obtained by reacting an ether urethane resin, which is obtained by reaction of polyether polyol and polyisocyanate, with hydroxyalkyl (meth)acrylate; or epoxy acrylate obtained by addition reaction of an epoxy resin and (meth)acrylic acid, and the like, but it is not limited thereto.

A kind of the reactive diluent monomer is not particularly limited as long as it includes a reactive functional group such as (meth)acryloyl group in the molecular structure. Such a monomer may act on controlling viscosity of the composition and embodying adhesion strength after curing. This monomer may include alkyl (meth)acrylate; a monomer containing a hydroxy group such as hydroxyethyl (meth)acrylate, hydroxybutyl (meth)acrylate or hydroxybutyl (meth)acrylate; a monomer containing a carboxyl group such as (meth)acrylic acid or β-carboxyethyl (meth)acrylate; a monomer containing an alkoxy group such as 2-(2-ethoxyethoxy)ethyl (meth)acrylate; a monomer containing an aromatic group such as benzyl (meth)acrylate or phenoxyethyl (meth)acrylate; a monomer containing a heterocylce residue such as tetrahydrofurfuryl (meth)acrylate) or (meth)acryloyl morpholine; or multifunctional acrylate, but it is not limited thereto.

The specific kind or weight ratio of the oligomer and the reactive diluent monomer is not particularly limited, and may be suitably selected considering viscosity of the desired composition and adhesion properties to be intended to embody after curing.

Said pressure sensitive adhesive composition may be thermo-curable or photo-curable, preferably said pressure sensitive adhesive composition is photocurable. When the pressure sensitive adhesive composition is photocurable, said monomeric or polymeric component may include the photocurable oligomer and the diluent monomers as described above, but preferably said monomeric or polymeric component may include photocurable syrup. Here, the photocurable syrup may be a monomer mixture that comprises alkyl (meth)acrylate and a hydrophilic monomer; or partially polymerized product of the monomer mixture.

Here, alkyl (meth)acrylate included in the monomer mixture is not particularly limited to any kind, and for example, alkyl (meth)acrylate having a linear or branched alkyl group having 1 to 14 carbon atoms may be used considering cohesiveness and glass transition temperature of the pressure sensitive adhesive. An example of such a monomer may include methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, hexyl (meth)acrylate, 2-ethylhexyl (meth)acrylate, 2-ethylbutyl (meth)acrylate, n-octyl (meth)acrylate, isooctyl (meth)acrylate, isononyl (meth)acrylate, lauryl (meth)acrylate and tetradecyl (meth)acrylate, and the like, and one or at least two of the forgoing in combination thereof may be used.

The hydrophilic monomer included in the monomer mixture may be a monomer having a polar functional group in its molecule. The hydrophilic monomer may prevent a whitening phenomenon from being generated in the pressure sensitive adhesive, and therefore the pressure sensitive adhesive may be more efficiently applied to an optical use.

As long as the hydrophilic monomer has a polar functional group in its molecule, it may be used without any particular limitation, but it is preferred to use a monomer represented by the following chemical formula 1, 2 or 3.

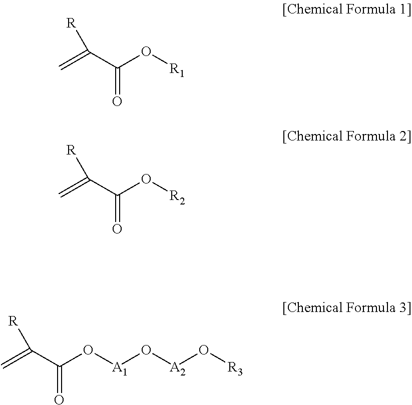

wherein, R represents hydrogen or an alkyl group, R₁ represents hydrogen or -A₃-C(═O)—OH, R₂ represents -A₄-OH, R₃ represents an alkyl group and A₁ to A₄ each independently represent alkylene.

In the chemical formulas 1 to 3, R may be, preferably, hydrogen or an alkyl group having 1 to 4 carbon atoms, and more preferably, hydrogen or a methyl group.

In addition, in R₁ to R₃ and A₁ to A₄ of the above chemical formulas 1 to 3, alkyl may be linear or branched alkyl having 1 to 20 carbon atoms, 1 to 16 carbon atoms, 1 to 12 carbon atoms, 1 to 8 carbon atoms or 1 to 4 carbon atoms, and alkylene may be linear, branched or cyclic alkylene having 1 to 20 carbon atoms, 1 to 16 carbon atoms, 1 to 12 carbon atoms, 1 to 8 carbon atoms or 1 to 4 carbon atoms.

Furthermore, in the above chemical formulas 1 to 3, alkyl or alkylene may be also, optionally, substituted by general substituents known in the chemical field, for example, halogen atom, a hydroxy group, a carboxyl group, a thiol group, an alkoxy group, an alkyl group, an alkenyl group or an alkynyl group, and the like.

Also, in a compound of chemical formula 1, R₁ may represent, preferably, hydrogen or —(CH₂)ₘ—C(═O)—OH, where m is an integer of 1 to 4. A specific example of the compound of chemical formula 1 may include (meth)acrylic acid or β-carboxyethyl (meth)acrylate, and the like, but it is not limited thereto.

Also, in a compound of chemical formula 2, R₂ may represent, preferably, —(CH₂)ₙ—C(═O)—OH, where n is an integer of 1 to 4. A specific example of the compound of chemical formula 2 may include hydroxyethyl (meth)acrylate or hydroxybutyl (meth)acrylate, and the like, but it is not limited thereto.

Also, in a compound of chemical formula 3, R₃ may be alkyl having 1 to 4 carbon atoms, and A₁ and A₂ may be each independently alkylene having 1 to 4 carbon atoms. A specific example of such a compound may include 2-(2-ethoxyethoxy)ethyl (meth)acrylate, but it is not limited thereto.

The monomer mixture in said photocurable syrup may comprise 50 to 99.9 parts by weight of alkyl (meth)acrylate and 0.1 to 50 parts by weight of a hydrophilic monomer, and preferably, 60 to 95 parts by weight of alkyl (meth)acrylate and 5 to 40 parts by weight of a hydrophilic monomer. The weight ratio of the hydrophilic monomer in said monomer mixture may be controlled considering effects of preventing whitening from being generated in the pressure sensitive adhesive, a handling property, a workability and a preservation stability, and the like. If said monomer of chemical formula 1 has too high ratio by weight, it is apprehended that heat is generated in the processes, so that process efficiency will be reduced. If the monomer of chemical formula 2 has too high ratio by weight, it is apprehended that storage stability of the pressure sensitive adhesive will be lowered. If the monomer of chemical formula 3 has too high ratio by weight, it is apprehended that the pressure sensitive adhesive softens too much, so that handling property will be lowered. Meanwhile, if the monomers of chemical formulas 1 to 3 have too low ratio by weight, it is apprehended that whitening of the pressure sensitive adhesive will be not effectively inhibited. Therefore, the ratios by weight of the monomers have to be controlled considering these facts. The unit “part by weight” in this document means ratio by weight or weight ratio, unless it is defined otherwise.

In one embodiment, the composition of said photocurable syrup may be further controlled, for satisfying with the required physical properties of the pressure sensitive adhesive, inhibiting a whitening phenomenon and securing durability.

That is, in one embodiment, said syrup may be a monomer mixture comprising (a) alkyl (meth)acrylate; (b) (meth)acrylic acid or a monomer of the following chemical formula 4; and (c) a hydrophilic monomer of the following chemical formula 5, a hydrophilic monomer of the above chemical formula 2 or a hydrophilic monomer of the above chemical formula 3. The photocurable syrup may be a partially polymerized product of said monomer mixture.

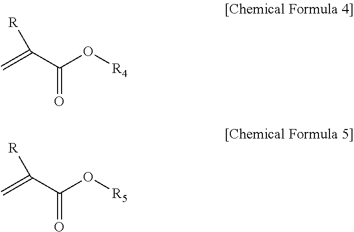

wherein, R represents hydrogen or an alkyl group, R₄ represents a monovalent moiety derived from a saturated aliphatic cyclic hydrocarbon, R₅ represents -A₅-C(═O)—OH, and A₅ represents alkylene.

In the above chemical formulas 4 and 5, R may be, preferably, hydrogen or an alkyl group having 1 to 4 carbon atoms, and more preferably, hydrogen or a methyl group.

Also, in the above chemical formulas 4 and 5, A₅ may be linear, branched or cyclic alkylene having 1 to 20 carbon atoms, 1 to 16 carbon atoms, 1 to 12 carbon atoms, 1 to 8 carbon atoms or 1 to 4 carbon atoms.

Also, in the above chemical formulas 4 and 5, alkyl or alkylene may be, optionally, substituted by general substituents known in the chemical field, for example, a halogen atom, a hydroxy group, a carboxyl group, a thiol group, an alkoxy group, an alkyl group, an alkenyl group or an alkynyl group, and the like.

Furthermore, in a compound of chemical formula 4, R₄ may be a monovalent moiety which is derived from a saturated aliphatic cyclic hydrocarbon having, preferably, 3 to 20 carbon atoms, and more preferably, 6 to 15 carbon atoms. An example of such a compound of chemical formula 4 may include isobornyl (meth)acrylate, and the like, but it is not limited thereto.

Furthermore, in a compound of chemical formula 5, R₅ may be, preferably, —(CH₂)ₘ—C(═O)—OH, wherein m is an integer of 1 to 4. An example of the compound of chemical formula 5 may include β-carboxyethyl (meth)acrylate, and the like, but it is not limited thereto.

Furthermore, specific examples of the above chemical formulas 2 and 3 are the same as mentioned above.

In the above embodiment, the monomer mixture may comprise 50 to 99.9 parts by weight of alkyl (meth)acrylate; 5 to 40 parts by weight of (meth)acrylic acid or a monomer of chemical formula 4; and 0.1 to 40 parts by weight of said hydrophilic monomer, and preferably, 60 to 95 parts by weight of alkyl (meth)acrylate; 10 to 30 parts by weight of (meth)acrylic acid or a monomer of chemical formula 4; and 5 to 30 parts by weight of said hydrophilic monomer. In the above composition, (meth)acrylic acid or the monomer of chemical formula 4 acts primary on securing durability of the pressure sensitive adhesive, and when its ratio by weight is too lowered, it is apprehended that the effect of securing durability will be slight. Also, if the ratio by weight of (meth)acrylic acid is too increased, it is apprehended that heat is largely caused, so that process efficiency will be lowered. If the ratio by weight of the monomer of chemical formula 4 is too increased, it is apprehended that adhesion of the pressure sensitive adhesive will be lowered. Therefore, the ratio by weight may be controlled considering these facts.

When said pressure sensitive adhesive composition comprises a partially polymerized product of the aforementioned monomer mixture as said syrup, a polymerization ratio of the monomer mixture or a conversion ratio of the monomer is not particularly limited. For example, said polymerization ratio or conversion ratio may be controlled considering process efficiency or the desired adhesion properties.

Here, the monomeric or polymeric component, or the pressure sensitive adhesive composition comprising the same may have a viscosity of about 1,000 to 8,000 cps, preferably about 1,000 to 6,000 cps, more preferably about 1,500 to 4,000 cps and most preferably 2,000 to 3,500 cps at 25° C. The viscosity may be controlled in such a range to secure process efficiency and to effectively maintain physical properties such as adhesion characteristics of the pressure sensitive adhesive. A method of controlling the viscosity of the monomeric or polymeric component or the pressure sensitive adhesive composition as above is not particularly limited. For example, when the composition is the aforementioned themocurable composition, a method of controlling solid content or molecular weight of the polymer or a dilution ratio with a solvent may be used. When it comprises a photocurable oligomer and a reactive diluent monomer, a method of controlling kinds of oligomer and/or monomer or a weight ratio may be used. When the monomer mixture or a partially polymerized product thereof is used, a method of controlling ratios by weight of monomers or a polymerization degree may be used.

Said pressure sensitive adhesive composition comprises a light scattering particle. The term “light scattering particle” means a particle which has the refractive index different from that of the pressure sensitive adhesive so as to provide the pressure sensitive adhesive with a characteristic being capable of diffusing or scattering light, as mentioned above. The term pressure sensitive adhesive, which is referred to when defining the relation of the refractive index with said light scattering particle, means a pressure sensitive adhesive formed by curing the pressures sensitive adhesive composition in which said light scattering particle is not included. Specifically, said light scattering particle may differ in a refractive index of the pressure sensitive adhesive by 0.05 to 1.0, preferably 0.05 to 0.6, and more preferably 0.05 to 0.4. Also, said light scattering particles may have the above relationship as well as higher refractive index over the pressure sensitive adhesive. If the difference of the refractive index is less than 0.05, it is apprehended that the effect of diffusing or scattering light will be slight. If it is in excess of 0.6, it is apprehended that the total light transmittance of the pressure sensitive adhesive is lowered, so that application for optical use will be difficult.

As long as said light scattering particle can have a good compatibility with other components in the composition and a good dispersing property and play the above role, their specific kind is not particularly limited. In addition, a shape of said particles may be any shape such as a sphere, a polyhedron or an amorphism, and preferably, a sphere. Here, the sphere includes substantial or approximate spheres as well as geometrically perfect spheres.

A specific example of the light scattering particles may include particles derived from organic materials such as an acrylic resin, a styrene resin, a urethane resin, a melamine resin, a benzoguanamine resin, an epoxy resin or a silicone resin; or particles derived from inorganic materials such as silica, titanium dioxide (TiO₂), fluorinated magnesium (MgF₂), zirconium oxide (ZrO₂), aluminum oxide (Al₂O₃) or glass, and the like, but it is not limited thereto. Here, the acrylic resin, the styrene resin or the urethane resin, and the like may form particles in a crosslinked or non-crosslinked state. As said light scattering particles, benzoguanamine-formaldehyde condensate (EPOSTAR M30: refractive index 1.66), melamine-formaldehyde condensate (EPOSTAR, refractive index 1.66), crosslinked poly(methylmethacrylate) product (EPOSTAR MX, refractive index 1.49), manufactured by Nippon Shokubai Co., Ltd., crosslinked poly(methacrylic acid methyl) (MBX, refractive index 1.49), crosslinked polystyrene (SBX, refractive index 1.59), manufactured by Sekisui Chemical Co., Ltd., silicone resin (toss pearl, refractive index 1.43) manufactured by Toshiba Silicone Co., Ltd., epoxy resin (Toray pearl, refractive index 1.59) manufactured by Toray Industries, Inc., polystyrene resin beads (KSR-3, refractive index 1.59) manufactured by Soken Chemical & Engineering Co., Ltd., polystyrene beads (GS-04595-6, refractive index 1.59) manufactured by Ganz or polystyrene beads (HR-59-40, refractive index 1.59) manufactured by Sunjin Chemical Co. Ltd., and the like may be used, without being limited thereto.

Said light scattering particles may have an average particle diameter of about 1,000 to 30,000 nm, preferably about 1,000 to 20,000 nm, more preferably about 1,000 to 10,000 nm and most preferably about 1,000 to 6,000 nm. If the light scattering particles have too low size, it is apprehended that the effect of scattering or diffusing light will be lowered. If it has too high size, it is apprehended that adhesion will be lowered.

A ratio by weight of the light scattering particles in said pressure sensitive adhesive composition may be changed considering the desired light scattering property or light diffusing property, which is not particularly limited. For example, said particles may be in a range of 0.01 to 50 parts by weight, 0.05 to 50 parts by weight, 0.05 to 20 parts by weight or 0.05 to 10 parts by weight, relative to 100 parts by weight of the monomeric or polymeric component. If the light scattering particles have too low ratio by weight, it is apprehended that the effect of scattering or diffusing light will be lowered. If it has too high ratio by weight, it is apprehended that adhesion will be lowered. Therefore, the ratio by weight may be controlled considering this fact.

Also, said pressure sensitive adhesive composition may further comprise a dye. Said dye may be suitably included in the pressure sensitive adhesive to control color of the pressures sensitive adhesive and to effectively inhibit whitening or yellowing phenomenon to be caused. Said dye is not particularly limited to any specific kind, and usual organic dyes used in coloring, for example, plastic materials may be used. For example, nitroso dyes, nitro dyes, azo dyes, triphenylmethane dyes, phthalic anhydride dyes, indigo dyes or anthraquinone dyes, and the like may be used, and preferably, anthraquinone dyes may be used as blue dyes. An example of dye which is capable of being suitably used herein may include MACROLEX series manufactured by LANXESS, and the like, but it is not limited thereto.

Here, an amount of the dye is not particularly limited, which may be suitably selected considering, for example, color of the pressure sensitive adhesive pad. For example, in the composition, said dye component may be included in an amount of 0.001 to 10 ppm, preferably 0.05 to 6 ppm, whereby it may prevent from lowering brightness, and the like, with effectively controlling color of the pressure sensitive adhesive.

Said pressure sensitive adhesive composition may comprise, optionally a multifunctional acrylate together with the aforementioned components. Especially, when the monomeric or polymeric component is the aforementioned photocurable syrup, the composition may comprise, preferably, said multifunctional acrylate, but it is not limited thereto. The kind of multifunctional acrylate, for example, difunctional acrylate such as 1,4-butanediol di (meth)acrylate, 1,6-hexanediol di(meth)acrylate, neopentylglycol di(meth)acrylate, polyethyleneglycol di(meth)acrylate, neopentylglycol adipate di(meth)acrylate, hydroxyl puivalic acid neopentylglycol di(meth)acrylate, dicyclopentanyl di(meth)acrylate, caprolactone modified dicyclopentenyl di(meth)acrylate, ethyleneoxide modified di(meth)acrylate, di(meth)acryloxy ethyl isocyanurate, allylated cyclohexyl di(meth)acrylate, tricyclodecanedimethanol (meth)acrylate, dimethylol dicyclopentane di(meth)acrylate, ethyleneoxide modified hexahydrophthalic acid di(meth)acrylate, tricylcodecane dimethanol (meth)acrylate, neopentylglycol modified trimethylpropane di(meth)acrylate, adamantane di(meth)acrylate or 9,9-bis[4-(2-acryloyloxyethoxy)phenyl]fluorene; trifunctional acrylate such as trimethylopropane tri(meth)acrylate, dipentaerythrytol tri(meth)acrylate, propionic acid modified dipentaerythritol tri(meth)acrylate, pentaerythritol tri(meth)acrylate, propyleneoxide modified trimethylolpropane tri(meth)acrylate, trifunctional urethane (meth)acrylate or tris(meth)acryloxy ethylisocyanurate; tetrafunctional arylate such as diglycerine tetra(meth)acrylate or pentaerythritol tetra(meth)acrylate; pentafunctional acrylate such as propionic acid modified dipentaerythritol penta(meth)acrylate; and hexafunctional acrylate such as dipentaerythritol hexa(meth)acrylate, caprolactone modified dipentaerythritol hexa(meth)acrylate or urethane (meth)acrylate (ex. a reactant of isocyanate monomer and trimethylolpropane tri(meth)acrylate) may be used, without being limited thereto.

The multifunctional acrylate may be included in an amount of 0.05 to 50 parts by weight, relative to 100 parts by weight of the monomeric or polymeric component, which may be changed considering process efficiency, or physical properties of the pressure sensitive adhesive pad.

When the pressure sensitive adhesive composition is formulated as a photocurable, said composition may further comprise a photoinitiator and a polymerization degree may be controlled depending on an amount of said component. As long as the photoinitiator can initiate a polymerization reaction via light irradiation, and the like, any photoinitiator may be used. For example, it may include alpha-hydroxyketone compounds (ex. IRGACURE 184, IRGACURE 500, IRGACURE 2959, DAROCUR 1173; manufactured by Ciba Specialty Chemicals); phenylglyoxylate compounds (ex. IRGACURE 754, DAROCUR MBF; manufactured by Ciba Specialty Chemicals); benzyldimethylketal compounds (ex. IRGACURE 651; manufactured by Ciba Specialty Chemicals); α-aminoketone compounds (ex. IRGACURE 369, IRGACURE 907, IRGACURE 1300; manufactured by Ciba Specialty Chemicals); monoacylphosphine compounds (MAPO) (ex. DAROCUR TPO; manufactured by Ciba Specialty Chemicals); bisacylphosphine compounds (BAPO) (ex. IRGACURE 819, IRGACURE 819DW; manufactured by Ciba Specialty Chemicals); phosphineoxide compounds (ex. IRGACURE 2100; manufactured by Ciba Specialty Chemicals); metallocene compounds (ex. IRGACURE 784; manufactured by Ciba Specialty Chemicals); iodonium salts (ex. IRGACURE 250; manufactured by Ciba Specialty Chemicals); and a mixture of at least one compound thereof (ex. DAROCUR 4265, IRGACURE 2022, IRGACURE 1300, IRGACURE 2005, IRGACURE 2010, IRGACURE 2020; manufactured by Ciba Specialty Chemicals), and the like, and one or two or more of the foregoing may be used, without being limited thereto.

The photoinitiator may be included in an amount of 0.05 to 20 parts by weight, relative to 100 parts by weight of the aforementioned monomeric or polymeric component, which may be changed considering process efficiency, or physical properties of the hardened material.

Also, said pressure sensitive adhesive composition may further comprise an antioxidant. Yellowing in the pressure sensitive adhesive may be effectively inhibited by including the antioxidant therein. The usable antioxidant is not particularly limited to any specific kind, wherein general components known in a field of preparing pressure sensitive adhesives may be used and its content may be appropriately controlled considering the desired physical properties. An example of the usable antioxidant may include compounds distributed as the trade name of Songnox series (manufactured by Songwon Industrial Co., Ltd., Songnox 1076, Songnox 1035, Songnox 1135, Songnox 1010, and the like), but it is not limited thereto.

Furthermore, said pressure sensitive adhesive composition may further comprise an agent for improving re-workability. By further comprising the agent for improving re-workability, workability and redetachability, and the like, may be improved in procedures of applying the pressure sensitive adhesive pad. The usable agent for improving re-workability is not limited to any specific kind, and various materials known in this field, such as fluorine compounds, silicon compounds or low molecular weight materials, and the like may be suitably used considering the desired physical properties. In addition, the content of said agent for improving re-workability is not particularly limited, and may be appropriately selected considering the desired physical properties and compositions, and the like.

Furthermore, said composition may, optionally, further comprise one or at least two additives of a thermo-curing agent, a catalyst, a UV hardener, a silane coupling agent, a scattering body, a UV stabilizer, a toning agent, a reinforcing agent, a filler, a defoamer, a surfactant and a plasticizer, and the like.

Said pressure sensitive adhesive layer formed by curing the above composition may have a thickness of about 0.1 to 10 mm, preferably about 0.1 to 5 mm, and more preferably about 0.1 to 2 mm. By controlling the thickness in the above range, the thinner and more uniform surface light source can be provided. However, said thickness may be changed depending on the specific application use.

As shown in FIG. 2, said backlight unit (2) may also further comprise a diffuser plate (40) attached on the pressure sensitive adhesive pad (30). The air layer between the substrate (10) and the diffuser plate (40) may be substantially removed by attaching the pressure sensitive adhesive pad to the substrate and then attaching the diffuser plate on the upper part to constitute a unit, whereby the brightness characteristic, and the like, may be improved.

Said diffuser plate (40) is not particularly limited to any specific kind, and general materials known in this field may be employed. In addition, as shown in FIG. 3, appropriate patterns (P) for reducing bright points may be also formed in said diffuser plate (40) considering patterns in the light emitting bodies (20).

As shown in FIG. 3, said backlight unit (3) may also further comprise a reflective layer (50) formed on the substrate (10). By forming the reflective layer (50), light emitted from the light emitting bodies (20) can be effectively refracted. Said reflective layer (50) is not particularly limited to any specific kind, and may be formed using general materials in this field.

The present invention also relates to a method of preparing a backlight unit comprising steps of: preparing a pressure sensitive adhesive pad using a pressure sensitive adhesive composition comprising a monomeric or polymeric component and a light scattering particle; and attaching said pressure sensitive adhesive pad to a substrate, on which a light emitting body is present.

Here, the method of preparing the pressure sensitive adhesive pad using the pressure sensitive adhesive composition is not particularly limited. For example, it may be prepared by coating the pressure sensitive adhesive composition in a pad shape and semi-curing or curing the coated pressure sensitive adhesive composition.

The method of coating the pressure sensitive adhesive composition is not particularly limited, and for example, the known method such as bar coating or roll coating may be applied. The method of curing or semi-curing the coated composition following coating is not particularly limited, and an appropriate photo-curing method or thermo-curing method is adapted considering composition of the used composition. For example, when the pressure sensitive adhesive composition is a thermo-curable composition, the coated composition may be semi-cured or cured through an appropriate drying, heating or aging process. When it is a photocurable composition, it may be semi-cured or cured through a method of irradiating electromagnetic wave, such as UV, which can affect the photoinitiator included in the composition and induce a polymerization reaction or a curing reaction. Here, the condition, such as temperature or time of drying, heating or aging, or light intensity or illuminance for irradiating electromagnetic wave, is not particularly limited, and may be suitably selected considering components or weight ratio thereof of the compositions or the desired degree of curing.

The present invention also relates to a method of preparing a backlight unit comprising steps of: coating a pressure sensitive adhesive composition comprising a monomeric or polymeric component and a light scattering particle on a substrate, on which a light emitting body is present; and curing or semi-curing said pressure sensitive adhesive composition coated on the substrate.

In the above method, the pressure sensitive adhesive pad is formed by a method comprising a step of coating the pressure sensitive adhesive composition directly on the substrate, and then curing or semi-curing the coated composition. The degree of process freedom may be much improved by using a method of directly coating the substrate, not a method of preparing the pressure sensitive adhesive pad separately and laminating it. The method of coating the substrate with the pressure sensitive adhesive composition herein is not particularly limited, and for example, the known method such as bar coating may be applied.

In addition, the thickness of coating layer in said coating process is not particularly limited, and may be changed depending on the specific application use of the backlight unit.

Following said coating step, a step of curing or semi-curing the coated pressure sensitive adhesive composition is carried out, and for example, the pressure sensitive adhesive pad having the pressure sensitive adhesive layer attached to the substrate is formed via this step.

The method of curing or semi-curing the coated composition is not particularly limited, and an appropriate photo-curing method or thermo-curing method is adapted considering components or weight ratio thereof of the used composition. For example, when the pressure sensitive adhesive composition is a thermo-curable composition, the coated composition may be cured or semi-cured by an appropriate drying, heating or aging process. When it is a photo-curable composition, it may be cured or semi-cured by a method of irradiating electromagnetic wave, such as UV, which can affect the photoinitiator included in the composition and induce a polymerization reaction or a curing reaction. Here, the condition, such as temperature or time of drying, heating or aging, or light intensity or illuminance for irradiating electromagnetic wave, is not particularly limited, and may be suitably selected considering components or weight ratio thereof of the composition or the desired degree of curing.

In the above methods, a step of attaching a diffuser plate on the coated pressure sensitive adhesive composition may be further carried out. The above step may be carried out before or after the aforementioned curing or semi-curing process.

The present invention also relates to a display device that comprises said backlight unit as a light source.

Said display device may be also a liquid crystal display device, wherein said device may further comprise a liquid crystal panel fixed on the upper part of said backlight unit. In addition, said display device may further comprise an optical film such as BEF (brightness enhancement film) or DBEF (dual brightness enhancement film).

Various elements constituting said display device, their arrangement or design methods, and the like are not particularly limited, and all general methods or elements constituting the device may be adapted.

### Advantageous Effects

In the present invention, the backlight unit includes a pressure sensitive adhesive that comprises a light scattering particle and is attached on a substrate, on which a light emitting body is present. Said pressure sensitive adhesive does not cause looseness, peel-off and curl even in a severe condition such as high temperature or high temperature and high humidity as well as a phenomenon such as yellowing or whitening. Therefore, the present invention may provide a unit having high brightness and excellent luminance uniformity, overcoming step height due to the light emitting body and having thin thickness, and is also advantageous to be applied to a flexible device.

### DESCRIPTION OF DRAWINGS

FIGS. 1 to 3 show schematics of illustrative embodiments of backlight units.

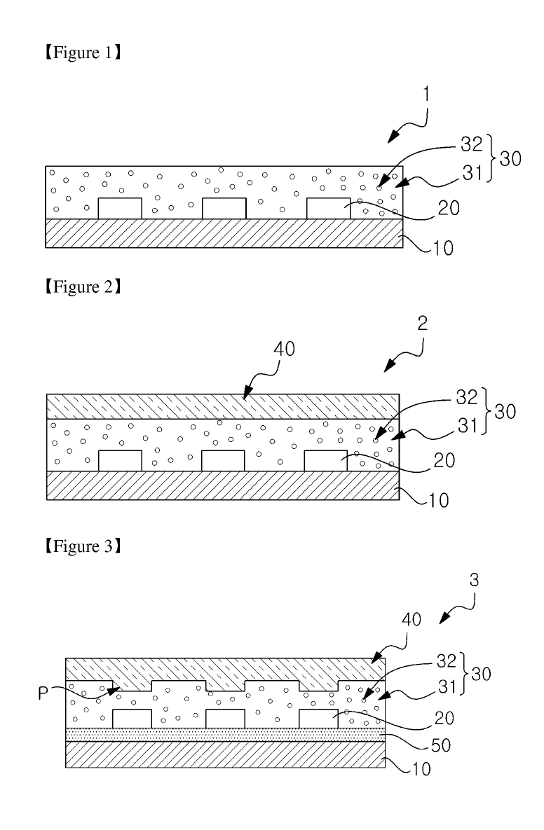

### MODE FOR INVENTION

Hereinafter, the present invention is explained in more detail via examples corresponding to the present invention and comparative examples not corresponding to the present invention, but the scope of the present invention is not restricted by the following examples.

### Example 1

A monomer mixture was prepared by mixing 92 parts by weight of ethylhexyl acrylate (EHA) and 8 parts by weight of acrylic acid (AA). Then, a photocurable syrup was prepared by adding an adequate amount of di(2-ethylhexyl) peroxydicarbonate (EHDC) to the monomer mixture, and then partially polymerizing the mixture by a bulk polymerization method so as to have a viscosity of approximately 3,000 cps at 25° C. Then, relative to 100 parts by weight of the photocurable syrup, 0.5 parts by weight of a photoinitiator (2,4,6-trimethylbenzoyl diphenyl phosphoine, TPO), 0.1 parts by weight of 1,6-hexanediol diacrylate (HDDA) and 0.25 parts by weight of light scattering particles (polystyrene beads, the refractive index: 1.59, the average diameter: 4,000 nm, HR-59-40, manufactured by Sunjin Chemical Co. Ltd.) were added thereto so as to prepare a pressure sensitive adhesive composition. Subsequently, the pressure sensitive adhesive composition was coated on a release film, such that a thickness after curing was 1.7 mm. Then, a pressure sensitive adhesive pad was prepared by irradiating the coated pressure sensitive adhesive with ultraviolet (UV) rays for 6 minutes. The irradiation of ultraviolet rays was performed by using a black light source under the condition where the distance between the coated pressure sensitive adhesive layer and the light source was maintained at 15 cm. Then, the pressure sensitive adhesive pad was attached on the LED array side of a printed circuit board (PCB)(PCB for 47 inch BLU, thickness: about 500 μm), which is used for a direct-type backlight unit, and on the LED array side of which LEDs were present in a predetermined pattern, so as to prepare a backlight unit having the overall thickness of 3 mm.

### Example 2

A backlight unit was prepared by using the same pressure sensitive adhesive composition as prepared in Example 1. However, the backlight unit (overall thickness: 3 mm), in which a pressure sensitive adhesive pad was attached on the LED array side of the PCB, was prepared by coating the pressure sensitive adhesive composition directly on the LED array side of a printed circuit board (PCB for 47 inch BLU, thickness: about 500 μm), on the LED array side of which LEDs were present in a predetermined pattern and which is used for preparing a direct type backlight unit, such that a thickness of the coated pressure sensitive adhesive composition after curing was 1.7 mm, and then irradiating the coated pressure sensitive adhesive composition with ultraviolet rays for approximately 6 minutes. The irradiation of ultraviolet rays was performed by using a black light source under the condition where the distance between the coated pressure sensitive adhesive layer and the light source was maintained at 15 cm.

### Example 3

The pressure sensitive adhesive composition was prepared by the same method as Example 1, except that the amount of 1,6-hexanediol diacrylate was changed to 0.5 parts by weight. Then the pressure sensitive adhesive composition was coated directly on a printed circuit board (PCB) having a thickness of about 1.2 mm on which LEDs were arrayed, and the coated pressure sensitive adhesive composition was cured by irradiation of UV rays by the same method as Example 1, so as to prepare a backlight unit.

### Example 4

A pressure sensitive adhesive composition was prepared by, an in adequate amounts, adding an isocyanate crosslinking agent (the trade name: Coronate L-55E, manufacturer: Nippon Polyurethane Industry Co.), a catalyst and light scattering particles (the refractive index: 1.59, the average diameter: 4,000 nm, polystyrene beads, HR-59-40, manufactured by Sunjin Chemical Co., Ltd.) to a thermocurable acrylic polymer containing hydroxyl groups (manufactured by Soken Company, the trade name: UT-3001, viscosity (25° C.): about 3,500 to 4,500 cps). Then, the pressure sensitive adhesive composition was coated directly on a printed circuit board (PCB) which has a thickness of about 1.2 mm, and on the upper side of which LEDs were arrayed, and the coated pressure sensitive adhesive composition was cured by being dried in an oven at 80′C for 20 minutes.

### Example 5

A monomer mixture was prepared by mixing 75 parts by weight of ethylhexyl acrylate (EHA), 15 parts by weight of acrylic acid (AA) and 10 parts by weight of hydroxyethyl acrylate. Then, a photocurable syrup was prepared by the same partially polymerizing method as in Example 1, except that the reaction condition of the bulk polymerization such as the reaction time was adjusted so as for the partially polymerized monomer mixture to have a viscosity of approximately 2,000 to 2,500 cps at 25′C. Then, relative to 100 parts by weight of the syrup, 0.7 parts by weight of a photoinitiator (2,4,6-trimethylbenzoyl diphenyl phosphoine, TPO), 0.3 parts by weight of 1,6-hexanediol diacrylate (HDDA), 15 parts by weight of light scattering particles (polystyrene beads, the refractive index: 1.59, the average diameter: 4,000 nm, HR-59-40, manufactured by Sunjin Chemical Co. Ltd.) and 1 ppm of a dye (Blue dye, MACROLEX Blue RR Gran manufactured by LANXESS) were added thereto so as to prepare a pressure sensitive adhesive composition. Then by using the prepared pressure sensitive adhesive composition, a backlight unit was prepared by the same method as in Example 1.

### Example 6

A backlight unit was prepared by using the same pressure sensitive adhesive composition as in Example 5. The backlight unit was prepared by, as in the method as described in Example 2, coating the pressure sensitive adhesive composition directly on a PCB and then curing it.

### Example 7

A monomer mixture was prepared by mixing 70 parts by weight of ethylhexyl acrylate (EHA), 10 parts by weight of acrylic acid (AA), 10 parts by weight of hydroxyethyl acrylate and 10 parts by weight of 2-(2-ethoxyethoxy)ethyl acrylate. Then, a photocurable syrup was prepared by the same partially polymerizing method as in Example 1, except that the reaction condition of the bulk polymerization such as the reaction time was adjusted so as for the partially polymerized monomer mixture to have a viscosity of approximately 3,000 to 3,500 cps at 25° C. Then, relative to 100 parts by weight of the syrup, 0.7 parts by weight of a photoinitiator (2,4,6-trimethylbenzoyl diphenyl phosphoine, TPO), 0.2 parts by weight of 1,6-hexanediol diacrylate (HDDA), 15 parts by weight of light scattering particles (polystyrene beads, the refractive index: 1.59, the average diameter: 4,000 nm, HR-59-40, manufactured by Sunjin Chemical Co. Ltd.) and 0.6 ppm of a dye (Blue dye, MACROLEX Blue RR Gran manufactured by LANXESS) were added thereto so as to prepare a pressure sensitive adhesive composition. Then by using the prepared pressure sensitive adhesive composition, a pressure sensitive adhesive pad having a thickness of 0.8 mm was prepared by the same method as in Example 1 and then a backlight unit was prepared by using the pressure sensitive adhesive pad and by the same method as in Example 1.

### Example 8

A backlight unit was prepared by using the same pressure sensitive adhesive composition as in Example 7. The backlight unit was prepared by, as in the method as described in Example 2, coating the pressure sensitive adhesive composition directly on a PCB and then curing it.

### Example 9

A monomer mixture was prepared by mixing 60 parts by weight of ethylhexyl acrylate (EHA), 10 parts by weight of acrylic acid (AA), 10 parts by weight of hydroxyethyl acrylate, 10 parts by weight of 2-(2-ethoxyethoxy)ethyl acrylate and 10 parts by weight of isobornyl acrylate. Then, a photocurable syrup was prepared by the same partially polymerizing method as in Example 1, except that the reaction condition of the bulk polymerization such as the reaction time was adjusted so as for the partially polymerized monomer mixture to have a viscosity of approximately 3,000 to 3,500 cps at 25° C. Then, relative to 100 parts by weight of the syrup, 0.7 parts by weight of a photoinitiator (2,4,6-trimethylbenzoyl diphenyl phosphoine, TPO), 0.3 parts by weight of 1,6-hexanediol diacrylate (HDDA), 12.5 parts by weight of light scattering particles (polystyrene beads, GS-0459S-6, manufactured by Ganz) and 1 ppm of a dye (Blue dye, MACROLEX Blue RR Gran manufactured by LANXESS) were added thereto so as to prepare a pressure sensitive adhesive composition. Then by using the prepared pressure sensitive adhesive composition, a pressure sensitive adhesive pad having a thickness of 0.8 mm was prepared by the same method as in Example 1 and then a backlight unit was prepared by using the pressure sensitive adhesive pad and by the same method as in Example 1.

### Example 10

A backlight unit was prepared by using the same pressure sensitive adhesive composition as in Example 9. The backlight unit was prepared by, as in the method as described in Example 2, coating the pressure sensitive adhesive composition directly on a PCB and then curing it.

### Experimental Example 1

### Endurance Test

The heat resistance endurance and the heat and moisture resistance endurance were evaluated with respect to the light sources (BLU) (sample) which had a size of 10 cm×30 cm (length×width), and which were prepared in Examples. The heat resistance endurance was evaluated by leaving the sample at 80° C. for 240 hours and then observing with naked eyes if bubbles, looseness and/or peel-off were generated. The heat and moisture resistance endurance was evaluated by leaving the sample at 60° C. and 90% relative humidity for 240 hours and then similarly observing with naked eyes if bubbles, looseness and/or peel-off were generated. Each evaluation standard is as follows.

<Evaluation of Bubble Production>

∘: no bubble is generated inside the pressure sensitive adhesive or the pressure sensitive adhesive interface, or bubbles have so small size that they are not observed with naked eye

x: single bubbles or agglomerate bubbles are observed with naked eyes inside the pressure sensitive adhesive or the pressure sensitive adhesive interface

<Evaluation of Looseness and Peel-Off>

∘: looseness and peel-off are not present at the interface between the pressures sensitive adhesive and the adherend

x: looseness or partial or full peel-off is caused at the interface between the pressure sensitive adhesive and the adherend

### Experimental Example 2

### Evaluation of Curl Property

The curl generation was evaluated after leaving the same samples as in Experimental Example 1 in the heat resistant condition. Specifically, the samples were left at 80° C. for 240 hours under the condition where it stood lengthwise, and then it was slowly cooled at room temperature for about 30 minutes. Then, after the lengthwise stood samples were positioned opposite flat glass substrates to be in contact with each other, it was evaluated by measuring the furthest distance from the standard glass substrates to the samples with a measuring tape if curl was generated.

Results of measurements were described in the following table 1.

TABLE 1

| | | Examples | | | | | | | | | |
|---|---|---|---|---|---|---|---|---|---|---|---|
| | | 1 | 2 | 3 | 4 | 5 | 6 | 7 | 8 | 9 | 10 |
| Endurance | Property of inhibiting | ∘ | ∘ | ∘ | ∘ | ∘ | ∘ | ∘ | ∘ | ∘ | ∘ |
| Evaluation | bubbles (heat resistance) | | | | | | | | | | |
| | Property of inhibiting | ∘ | ∘ | ∘ | ∘ | ∘ | ∘ | ∘ | ∘ | ∘ | ∘ |
| | bubbles (heat and | | | | | | | | | | |
| | moisture resistance) | | | | | | | | | | |
| | Looseness/Peel-off | ∘ | ∘ | ∘ | ∘ | ∘ | ∘ | ∘ | ∘ | ∘ | ∘ |
| | (heat resistance) | | | | | | | | | | |
| | Looseness/Peel-off (heat | ∘ | ∘ | ∘ | ∘ | ∘ | ∘ | ∘ | ∘ | ∘ | ∘ |
| | and moisture resistance) | | | | | | | | | | |

| | | | | | | | | | | |
|---|---|---|---|---|---|---|---|---|---|---|
| Curl Evaluation (cm) | 0 | 0 | 0 | 0 | 0 | 0 | 0 | 0 | 0 | 0 |

It can be seen from the results of the above table 1 that Examples of the present invention represent excellent endurance and curl property, and the like.

[Description of References]

| | |
|---|---|
| 1, 2, 3: Backlight unit | |
| 10: Substrate | 20: Light emitting body |
| 30: Pressure sensitive adhesive pad | 31: Pressure sensitive adhesive |
| 32: Light scattering particles | 40: Diffuser plate |
| 50: Reflective layer | |

1. A backlight unit comprising:
a substrate, on which a light emitting body is present; and
a pressure sensitive adhesive pad that is attached on said substrate, the pressure sensitive adhesive pad comprising a pressure sensitive adhesive layer which is a cured product of a pressure sensitive adhesive composition comprising a monomeric or polymeric component and a light scattering particle.

2. The backlight unit according to claim 1, wherein the light emitting body is a light emitting diode.

3. The backlight unit according to claim 1, wherein the monomeric or polymeric component comprises an acrylic polymer that has a crosslinkable functional group.

4. The backlight unit according to claim 1, wherein the monomeric or polymeric component comprises a photocurable oligomer; and a reactive diluent monomer.

5. The backlight unit according to claim 1, wherein the monomeric or polymeric component is a monomer mixture or a partially polymerized product of said monomer mixture, said monomer mixture comprising alkyl (meth)acrylate; and at least one hydrophilic monomer selected from the group consisting of a monomer of the following chemical formula 1, a monomer of the following chemical formula 2 and a monomer of the following chemical formula 3: 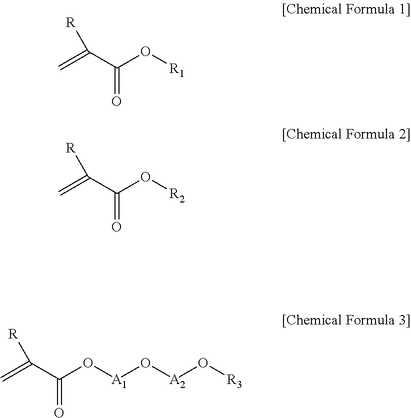
wherein R represents hydrogen or an alkyl group, R₁ represents hydrogen or -A₃-C(═O)—OH, R₂ represents -A₄-OH, R₃ represents an alkyl group, where A₁ to A₄ each independently represents an alkylene.

6. The backlight unit according to claim 1, wherein the monomeric or polymeric component is a monomer mixture or a partially polymerized product of said monomer mixture, said monomer mixture comprising alkyl (meth)acrylate; (meth)acrylic acid or a monomer of the following chemical formula 4; and at least one hydrophilic monomer selected from the group consisting of a monomer of the following chemical formula 2, a monomer of the following chemical formula 3 and a monomer of the following chemical formula 5: 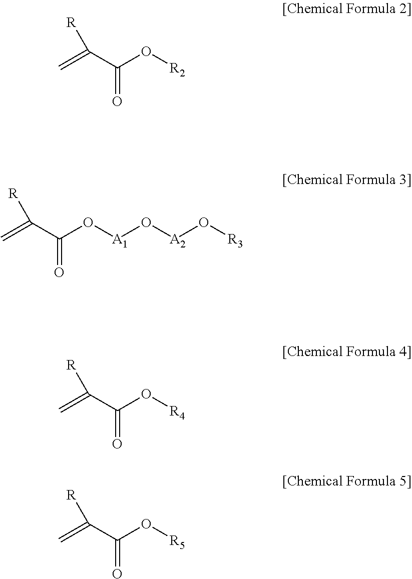
wherein, R represents hydrogen or an alkyl group, R₂ represents -A₄-OH, R₃ represents an alkyl group, R₄ represents a monovalent moiety derived from a saturated aliphatic cyclic hydrocarbon, R₅ represents -A₅-C(═O)—OH, and A₁, A₂, A₄ and A₅ each independently represent an alkylene.

7. The backlight unit according to claim 1, wherein the refractive index of the light scattering particle is different from that of the pressure sensitive adhesive by 0.05 to 1.0.

8. The backlight unit according to claim 1, wherein the refractive index of the light scattering particle is different from that of the pressure sensitive adhesive by 0.05 to 0.6.

9. The backlight unit according to claim 1, wherein the light scattering particles is at least one selected from the group consisting of an acrylic resin particle, a styrene resin particle, an urethane resin particle, a melamine resin particle, a benzoguanamine resin particle, an epoxy resin particle, a silicone resin particle, a silica particle, a titanium dioxide particle, a fluorinated magnesium particle, a zirconium oxide particle, an aluminum oxide particle and a glass particle.

10. The backlight unit according to claim 1, wherein the light scattering particle has an average particle diameter of 1,000 to 30,000 nm.

11. The backlight unit according to claim 1, wherein the pressure sensitive adhesive composition comprises 0.01 to 50 parts by weight of the light scattering particle, relative to 100 parts by weight of the monomeric or polymeric component.

12. The backlight unit according to claim 1, wherein the pressure sensitive adhesive composition further comprises a dye.

13. The backlight unit according to claim 1, wherein the pressure sensitive adhesive composition further comprises a multifunctional acrylate.

14. The backlight unit according to claim 1, wherein the pressure sensitive adhesive composition further comprises a photoinitiator.

15. The backlight unit according to claim 1, wherein the pressure sensitive adhesive composition further comprises an antioxidant.

16. The backlight unit according to claim 1, wherein the pressure sensitive adhesive composition further comprises an agent for improving re-workability.

17. The backlight unit according to claim 1, further comprising a diffuser plate attached on the pressure sensitive adhesive pad.

18. A method of preparing a backlight unit comprising steps of:
preparing a pressure sensitive adhesive pad using a pressure sensitive adhesive composition comprising a monomeric or polymeric component and a light scattering particle; and
attaching said pressure sensitive adhesive pad to a substrate, on which a light emitting body is present.

19. A method of preparing a backlight unit comprising steps of:
coating a pressure sensitive adhesive composition comprising a monomeric or polymeric component and a light scattering particle on a substrate, on which a light emitting body is present; and curing or semi-curing said pressure sensitive adhesive composition coated on the substrate.

20. A display device which comprises the backlight unit according to claim 1 as a light source.
